(19) United States
(12) Patent Application Publication
(10) Pub. No.: US 2016/0372906 A1
(43) Pub. Date: Dec. 22, 2016

(54) GROMMET WATERPROOFING SHEET AND WIRE HARNESS

(71) Applicant: Sumitomo Wiring Systems, Ltd., Yokkaichi (JP)

(72) Inventors: Masataka WAKABAYASHI, Yokkaichi (JP); Minoru FUKUDA, Yokkaichi (JP)

(21) Appl. No.: 15/183,120

(22) Filed: Jun. 15, 2016

(30) Foreign Application Priority Data
Jun. 17, 2015 (JP) 2015122236

(51) Int. Cl. H02G 3/22

(52) U.S. Cl. CPC H02G 3/22

(57) ABSTRACT

A grommet waterproofing sheet and a wire harness that enable moisture to be effectively supplied to a waterproofing agent that fills a portion to be covered by an electrical wire group support tube portion of a grommet, to enable the waterproofing agent to be hardened, and to better waterproof the space between electrical wires. The wire harness includes electrical wires and a grommet waterproofing sheet that includes a shape-memory resin sheet having moisture permeability and has shape memory according to which micro bumps are formed when heated to its glass transition temperature. A waterproofing agent is applied to the grommet waterproofing sheet, which is then heated to its glass transition temperature, so that it restores its remembered shape, water molecules that have passed through the waterproofing sheet shape cause the waterproofing agent to cure, and then the electrical wire group support tube portion is placed over the waterproofing sheet.

This application claims the benefit of Japanese Application No. JP2015-122236, filed on Jun. 17, 2015, the contents of which are hereby incorporated by reference in their entirety.

### FIELD

The present invention relates to a grommet waterproofing sheet for performing waterproofing using a waterproofing agent that hardens by absorbing moisture, and also relates to a wire harness.

### BACKGROUND

Conventionally, in the case where a wire harness is arranged so as to pass through the vehicle body panel in the engine room or the like of an automobile, it is common to hold the wire harness by inserting it through a grommet and attaching the grommet to an attachment hole formed in the vehicle body panel. There are also cases where liquid-tightness is required at the location where the grommet is attached, in order to prevent water from intruding through the spaces between the electrical wires of the wire harness (e.g., see JP H10-224961A, which is hereinafter referred to as Patent Document 1).

In the grommet attachment portion disclosed in Patent Document 1, the water stopping structure for preventing the flow of water between electrical wires is realized by arranging the electrical wires side-by-side in parallel on a waterproofing sheet, applying a silicone material, and then rolling up the waterproofing sheet to cause the silicone material to fill the space between the electrical wires.

FIG. 7 shows a water stopping structure that is substantially the same as the water stopping structure for preventing the flow of water between electrical wires in the grommet attachment portion disclosed in Patent Document 1. This water stopping structure achieves liquid-tightness through the following four steps, in order to ensure liquid-tightness by blocking the gaps between electrical wires in the portion covered by an electrical wire group support tube portion 3a of a grommet 3. In the first step, as shown in FIG. 7A, a group of electrical wires W is bound at two locations by pieces of adhesive tape 5a, and a waterproofing agent 4 such as a one-part silicone agent is applied to a urethane sheet 20 having a width that conforms to the gap between the two bound locations. In the second step, as shown in FIG. 7B, the urethane sheet 20 is wrapped around the group of electrical wires in the portion that is to be covered by the electrical wire group support tube portion 3a of the grommet 3, thus causing the waterproofing agent 4 to move into the space between the electrical wires, and then the two end portions of the urethane sheet 20 are taped using pieces of adhesive tape 5b. In the third step, as shown in FIGS. 7B and 7C, the electrical wire group support tube portion 3a of the grommet 3 is placed over the wrapped urethane sheet 20. In the fourth step, as shown in FIG. 7C, the two end portions of the grommet 3 are then taped using pieces of adhesive tape 5c. Liquid-tightness is obtained by curing of the waterproofing agent 4 that moved into the space between the electrical wires.

However, in the conventional method shown in FIGS. 7A to 7C, the curing of the silicone agent used as the waterproofing agent requires a sufficient humidity (e.g., a relative humidity of 75% or more), and therefore there are problems such as that there are cases where unstable portions in a sol-gel state remain, and the ability to achieve waterproofing of the space between electrical wires decreases or becomes unstable. Also, the grommet is attached even if the silicone agent has not hardened, thus leading to the problem of difficulty in wire harness quality management.

The present design was achieved in order to solve the above-described issues, and an object thereof is to provide a grommet waterproofing sheet and a wire harness that enable moisture to be effectively supplied to a waterproofing agent that fills and conceals a portion that is to be covered by an electrical wire group support tube portion of a grommet, enable the waterproofing agent to be effectively hardened, and enable increasing and stabilizing the ability to waterproof the space between electrical wires.

### SUMMARY

In order to achieve the above-described object, a grommet waterproofing sheet according to one aspect is a grommet waterproofing sheet for concealing a waterproofing agent that hardens by absorbing moisture, the waterproofing agent being applied to a sheet surface of the grommet waterproofing sheet, and the grommet waterproofing sheet being wrapped around a group of electrical wires so as to conceal a portion that is to be covered by an electrical wire group support tube portion of a grommet, thus causing the waterproofing agent to move into space between the electrical wires and harden, wherein the grommet waterproofing sheet is constituted by a shape-memory resin sheet that is moisture permeable, and has shape memory according to which micro bumps are formed on the sheet surface when heated to a glass transition temperature.

According to this configuration, when the waterproofing sheet is wrapped around the group of electrical wires so as to cause the waterproofing agent to move into the space between the electrical wires, and is then heated to the glass transition temperature, micro bumps are formed on the sheet surface, and the surface area is increased, thus making it possible to increase the area of contact between the waterproofing agent and the waterproofing sheet. Accordingly, it is possible to increase the number of water molecules that pass through the waterproofing sheet, thus making it possible to effectively supply moisture to the waterproofing agent that has moved into the space between the electrical wires, cause the waterproofing agent to harden rapidly and reliably, and increase the ability to waterproof the space between the electrical wires.

Also, in order to achieve the above-described object, a wire harness may include: a group of electrical wires; the grommet waterproofing sheet described above, a waterproofing agent that hardens by absorbing moisture being applied to a sheet surface of the grommet waterproofing sheet; and a grommet that has an electrical wire group support tube portion and blocks a through-hole provided in a vehicle body panel, wherein the grommet waterproofing sheet is wrapped around the group of electrical wires so as to conceal the group of electrical wires, adhesive tape is wrapped around two end portions of the grommet waterproofing sheet so as to fix the two end portions, the waterproofing agent is caused to move into space between the electrical wires, the grommet waterproofing sheet restores the remembered shape due to the grommet waterproofing sheet being heated to the glass transition temperature, water molecules that have passed through the grommet waterproofing sheet having the restored shape cause the waterproofing agent to cure, and then the electrical wire group support tube portion of the grommet is placed over the waterproofing sheet.

According to this configuration, when the waterproofing sheet is wrapped around the group of electrical wires and fixed so as to cause the waterproofing agent to move into the space between the electrical wires, and is then heated to the glass transition temperature, micro bumps are formed on the sheet surface, and the surface area is increased, thus making it possible to increase the area of contact between the waterproofing agent and the waterproofing sheet. Accordingly, it is possible to increase the number of water molecules that pass through the waterproofing sheet, thus making it possible to effectively supply moisture to the waterproofing agent that has moved into the space between the electrical wires, cause the waterproofing agent to harden rapidly and reliably, and increase the ability to waterproof the space between the electrical wires.

Also, the grommet is attached after the waterproofing agent has been cured in this way, and therefore the amount of variation in waterproofing performance between products decreases, and quality management can be performed more reliably and easily.

Therefore, it is possible to provide a grommet waterproofing sheet and a wire harness that enable moisture to be effectively supplied to a waterproofing agent that fills and conceals a portion that is to be covered by an electrical wire group support tube portion of a grommet, enable the waterproofing agent to be effectively hardened, and enable increasing and stabilizing the ability to waterproof the space between electrical wires.

### DRAWINGS

FIG. 1 is a plan view showing a grommet waterproofing sheet according to one embodiment, in a state before being wrapped around a group of electrical wires;

FIG. 2 is a plan view showing the grommet waterproofing sheet according to the embodiment, in a state after being wrapped around the group of electrical wires;

FIG. 3 is a plan view of a grommet that is to cover the portion of the group of electrical wires that is wrapped with the grommet waterproofing sheet according to the embodiment;

FIG. 4 is a plan view of a wire harness according to the embodiment;

FIG. 5 is a plan view showing the state of a sheet surface after heating of the grommet waterproofing sheet according to the embodiment;

FIG. 6 is an illustrative view showing a waterproofing structure of the wire harness according to the embodiment; and

FIGS. 7A to 7C show the waterproofing structure of a conventional wire harness, where FIG. 7A is a plan view showing a state before a waterproofing sheet is wrapped around a group of electrical wires, FIG. 7B is a plan view showing a state that is after the waterproofing sheet has been wrapped around the group of electrical wires and before a grommet is placed thereon, and FIG. 7C is a plan view of the completed wire harness after the grommet has been placed on the group of electrical wires.

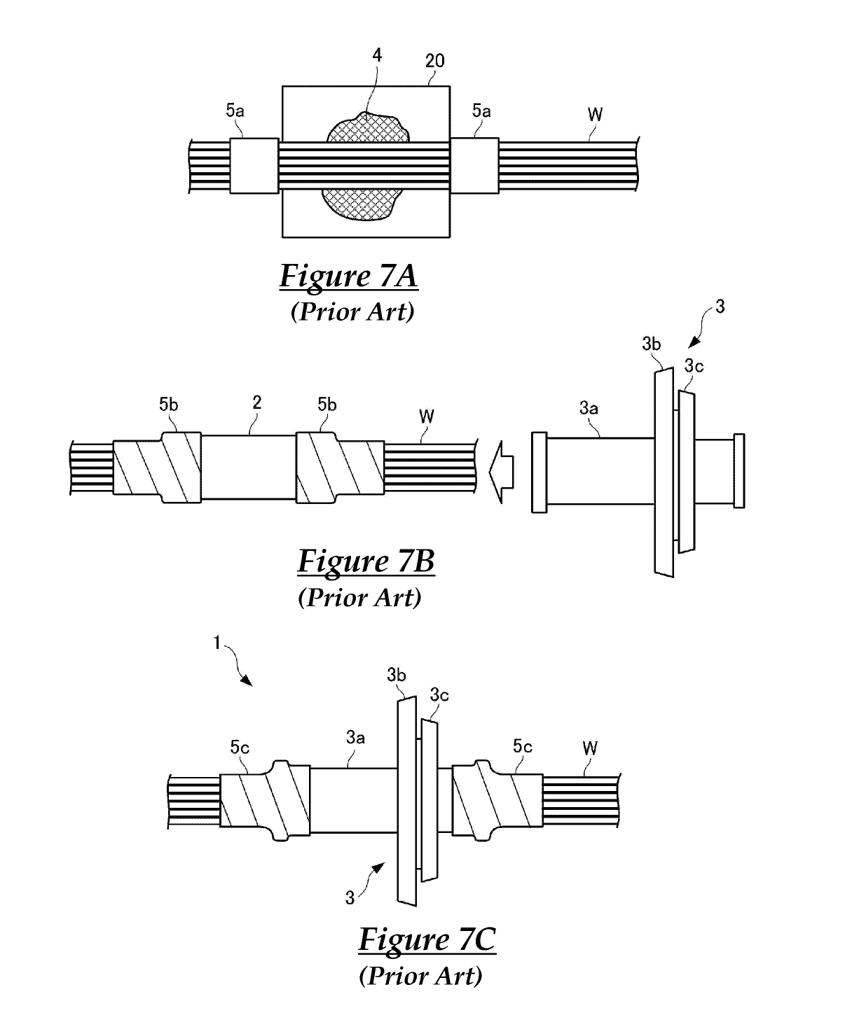

### DESCRIPTION

Hereinafter, an embodiment will be described with reference to the drawings.

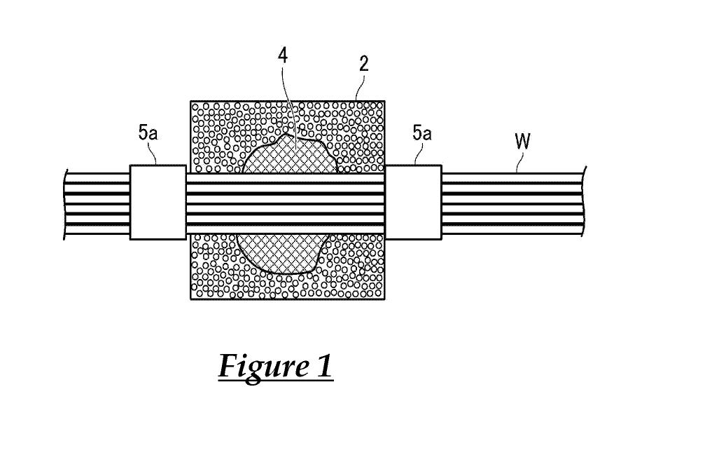

As shown in FIGS. 1 to 4, a wire harness 1 includes a group of electrical wires W, a grommet waterproofing sheet 2 whose sheet surface has a waterproofing agent 4 applied thereon, and a grommet 3.

The group of electrical wires W is obtained by bundling multiple core wires, which are sheathed wires, or multiple core wires and a ground wire by partially wrapping pieces of adhesive tape 5a around them at multiple locations as shown in FIG. 1. The locations wrapped by the pieces of adhesive tape 5a are at positions on two sides, avoiding the portion that is to be covered by an electrical wire group support tube portion 3a of the grommet 3.

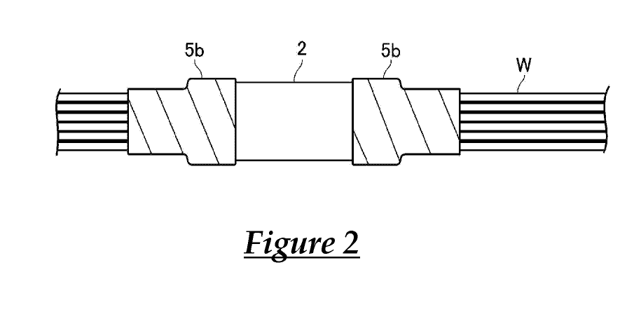

A waterproofing agent 4 that hardens by absorbing moisture is applied to the sheet surface of the grommet waterproofing sheet 2 (see FIG. 1), and then the grommet waterproofing sheet 2 is wrapped around the group of electrical wires W so as to cover the portion that is to be covered by the electrical wire group support tube portion 3a of the grommet 3 (see FIG. 2), thus causing the waterproofing agent 4 to move into the space between the electrical wires, and concealing the waterproofing agent 4 that hardens by absorbing moisture.

As shown in FIG. 2, the grommet waterproofing sheet 2 is wrapped so as to conceal the group of electrical wires W, and is fixed due to pieces of adhesive tape 5b being wrapped around the two end portions thereof.

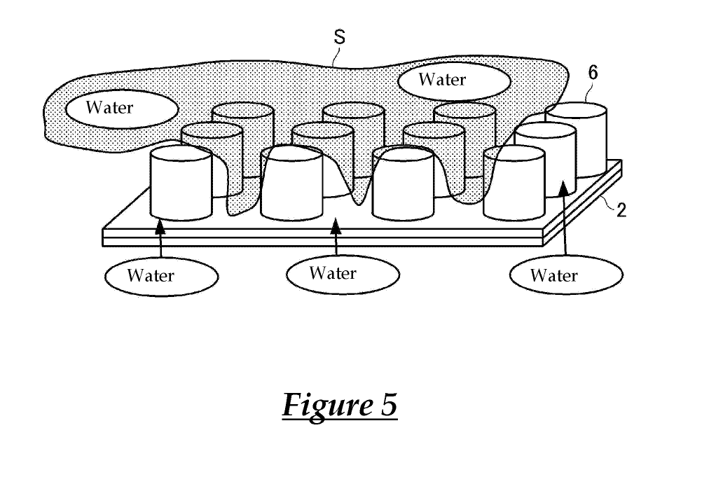

The grommet waterproofing sheet 2 is constituted by a shape-memory resin sheet that is moisture permeable. This sheet has shape memory according to which micro bumps 6 shown in FIG. 5 are formed on the sheet surface when heated to its glass transition temperature (e.g., 80° C.).

More specifically, a shape-memory resin sheet that is moisture permeable is heated to 80° C. so as to become softened, and is then pressed with a predetermined contact pressure onto an uneven surface of a mold that has micro bumps on its surface, thus forming micro bumps on the pressed surface of the shape-memory resin sheet. The shape-memory resin sheet is then further heated to 90° C., for example, and kept at that temperature for a certain period of time in order to remember the micro bump shape, then returned to 80° C. so as to return to the softened state, and pressed onto the smooth surface of another mold so as to return to the initial smooth surface. The temperature is then lowered to room temperature, thus obtaining a smooth resin sheet that remembers the micro bump shape.

When the smooth grommet waterproofing sheet 2 with the remembered micro bump shape is heated to its glass transition temperature of 80° C., it restores the remembered shape having the micro bumps 6 shown in FIG. 5. Due to the grommet waterproofing sheet 2 restoring the remembered shape having the micro bumps 6 at this time, the micro holes that contributed to moisture permeability increase in size, thus significantly increasing the moisture permeability.

A sheet made of a polyurethane-based shape memory polymer, for example, may be used as the shape-memory resin sheet that has moisture permeability (e.g., see S. Hayashi, T. Saji, T. Miwa, “High Moisture Permeability Polymer for Textile Applications”, Mitsubishi Heavy Industries Technical Review, Vol. 31, No. 1 (1994-1)). The polyurethane-based shape-memory polymer disclosed in the above document has a property of increasing in moisture permeability upon reaching its glass transition temperature, and thus when used as the waterproofing sheet 2 of the present embodiment, it is possible to further increase the ability to supply moisture to the waterproofing agent 4 after the waterproofing sheet 2 has been heated to its glass transition temperature to restore the micro bumps 6.

The waterproofing agent 4 is applied to the sheet surface of the waterproofing sheet 2 on the side on which the micro bumps 6 are formed. FIG. 5 shows a configuration in which the micro bumps 6 are shaped as circular column-shaped protrusion portions that rise from the sheet surface, but the shape of the micro bumps 6 is not limited to this, and any shape may be used as long as it is a shape that increases the surface area of the sheet surface. By increasing the surface area of the sheet surface as shown in FIG. 5, the waterproofing agent 4 (not shown) can be supplied with an even larger amount of moisture S that has passed through the side of the waterproofing sheet 2 on which the micro bumps 6 are not formed.

The waterproofing agent 4 is a waterproofing agent that hardens by absorbing moisture. Besides a one-part silicone agent that is used conventionally, the waterproofing agent 4 may be a sealing material that is moisture curing silicone-based, modified silicone-based, polyurethane-based, polysulfide-based, or the like.

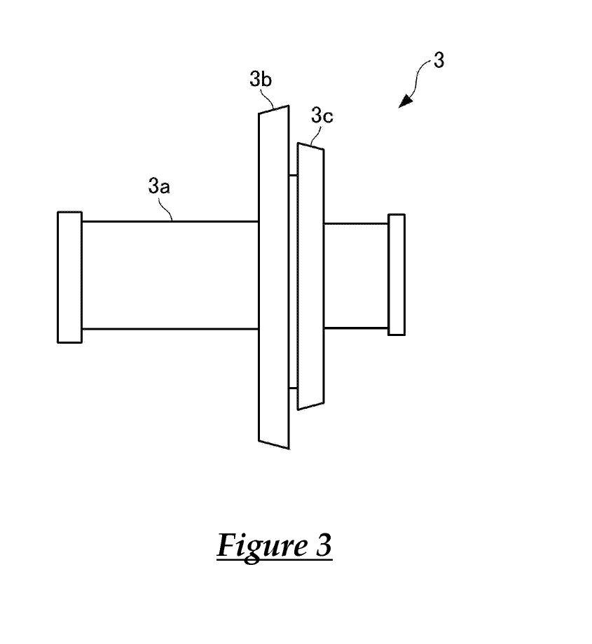

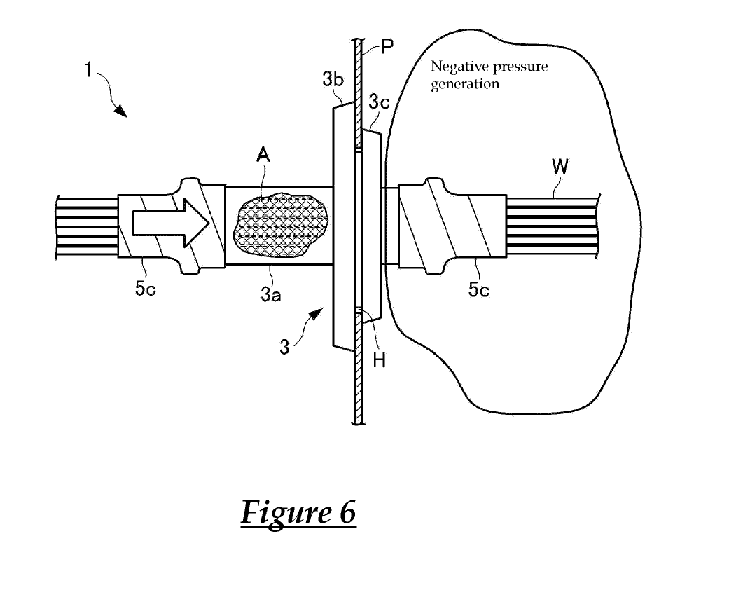

As shown in FIG. 3, the grommet 3 has the electrical wire group support tube portion 3a, a flange portion 3b that supports the electrical wire group support tube portion 3a, and a pedestal portion 3c provided on the outer circumferential end of the flange portion 3b on one side. As shown in FIG. 6, a through-hole H is provided in a vehicle body panel P that separates the engine compartment from the vehicle interior, and the pedestal portion 3c is passed through the through-hole H from the vehicle interior side so as to become fitted to the peripheral edge portion of the through-hole H.

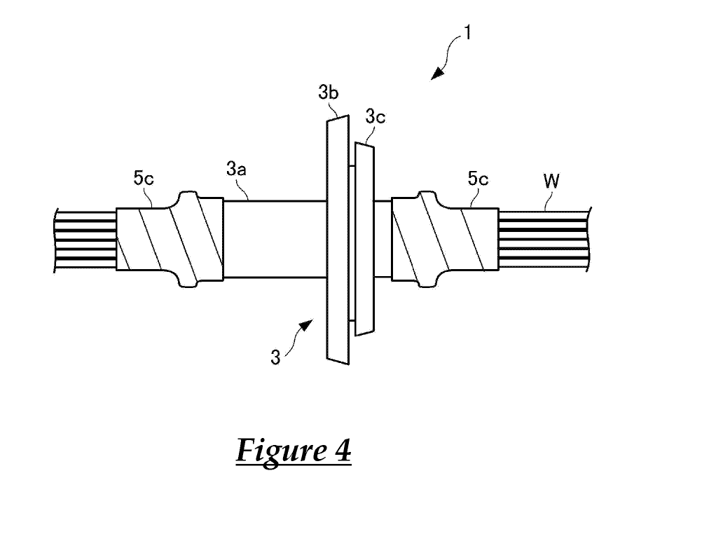

As shown in FIGS. 1 to 4, the wire harness 1 has a configuration in which the grommet waterproofing sheet 2 is wrapped around the group of electrical wires W (FIG. 2) so as to cause the waterproofing agent 4 to move into the space between the electrical wires, and then the grommet waterproofing sheet 2 is heated to its glass transition temperature to cause the grommet waterproofing sheet 2 to restore its remembered shape (FIG. 5) and increase the moisture permeability thereof. Water molecules that pass through the grommet waterproofing sheet 2 from the outside cause the waterproofing agent 4 to cure, and then the electrical wire group support tube portion 3a of the grommet 3 shown in FIG. 3 is placed over the waterproofing sheet 2 (FIG. 4).

Manufacturing steps will be described below in more detail.

(1) First, as shown in FIG. 1, the group of electrical wires W is partially bound by wrapping pieces of adhesive tape 5a around it at two locations, namely positions on two sides of the portion of the group of electrical wires W that is to be covered by the electrical wire group support tube portion 3a of the grommet 3. Then, the waterproofing agent 4 is applied to the shape-memory resin sheet 2 that is moisture permeable and has a width conforming to the gap between the pieces of adhesive tape 5a. The application task is easy because the micro bumps 6 have not yet been formed on the waterproofing sheet 2.

(2) Next, as shown in FIG. 2, the waterproofing sheet 2 is wrapped around the portion of the group of electrical wires W between the pieces of adhesive tape 5a, and then the two end portions of the waterproofing sheet 2 are taped using pieces of adhesive tape 5b. Accordingly, the waterproofing agent 4 is caused to move into the space between the electrical wires.

(3) In this state, the waterproofing sheet 2 is heated to its glass transition temperature using a dryer, a heater, or the like, thus restoring the remembered shape as shown in FIG. 5. The waterproofing sheet 2 is then left in a room with a predetermined high humidity to cause the waterproofing agent 4 to cure with water molecules that have passed through the waterproofing sheet 2. In this case, due to the cooperative effect of the moisture permeability of the waterproofing sheet 2 and the moisture absorbency of the waterproofing agent 4, the amount of water molecules that passes through the waterproofing sheet 2 reaches an amount sufficient for causing the waterproofing agent 4 to harden in a drastically shorter amount of time compared to the case of using a conventional resin sheet that is not moisture permeable. Accordingly, the waterproofing agent 4 is cured in a short amount of time.

(4) After curing of the waterproofing agent 4, as shown in FIG. 4, the electrical wire group support tube portion 3a of the grommet 3 shown in FIG. 3 is placed over the waterproofing sheet 2 that was wrapped around the group of electrical wires, and then the two end portions of the grommet 3 are taped using pieces of adhesive tape 5c, thus completing the manufacturing of the wire harness 1.

As shown in FIG. 6, even if the wire harness 1 manufactured as described above is subjected to negative pressure in the engine compartment that is partitioned by the vehicle body panel P, the intrusion of water into the vehicle interior can be reliably prevented due to the space between the electrical wires being blocked by the complete hardening of the waterproofing agent 4 that moved into the space between the electrical wires in the portion covered by the electrical wire group support tube portion 3a of the grommet 3.

With the grommet waterproofing sheet 2 of the present embodiment, the waterproofing sheet 2 is wrapped around the group of electrical wires W so as to cause the waterproofing agent 4 to move into the space between the electrical wires, and then when heated to its glass transition temperature, the micro bumps 6 are formed in the sheet surface, thus increasing the surface area. This makes it possible to increase the area of contact between the waterproofing agent 4 and the waterproofing sheet 2. Accordingly, the number of water molecules that pass through the waterproofing sheet 2 can be increased, thus making it possible to effectively supply moisture to the waterproofing agent 4 that has moved into the space between the electrical wires so as to cause the waterproofing agent 4 to harden rapidly and reliably, and making it possible to increase the ability to waterproof the space between the electrical wires.

With the wire harness 1 according to the present embodiment, the waterproofing sheet 2 is wrapped around the group of electrical wires W and fixed so as to cause the waterproofing agent 4 to move into the space between the electrical wires, and then when heated to its glass transition temperature, the micro bumps 6 are formed in the sheet surface, thus increasing the surface area. This makes it possible to increase the area of contact between the waterproofing agent 4 and the waterproofing sheet 2. Accordingly, the number of water molecules that pass through the waterproofing sheet 2 can be increased, thus making it possible to effectively supply moisture to the waterproofing agent 4 that has moved into the space between the electrical wires so as to cause the waterproofing agent 4 to harden rapidly and reliably, and making it possible to increase the ability to waterproof the space between the electrical wires.

Also, with the present wire harness, the waterproofing agent can be cured in a short amount of time by employing the waterproofing sheet that has moisture permeability, and since the grommet is attached after the waterproofing agent has been cured, the amount of variation in waterproofing performance between products decreases, and quality management can be performed more reliably and easily.

The present embodiment has effects of enabling moisture to be effectively supplied to a waterproofing agent that fills and conceals a portion that is to be covered by an electrical wire group support tube portion of a grommet, enabling the waterproofing agent to be effectively hardened, and enabling increasing and stabilizing the ability to waterproof the space between electrical wires. The present embodiment is useful to general grommet waterproofing sheets and wire harnesses that perform waterproofing using a waterproofing agent that hardens by absorbing moisture.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A grommet waterproofing sheet for concealing a waterproofing agent that hardens by absorbing moisture, the waterproofing agent being applied to a sheet surface of the grommet waterproofing sheet, and the grommet waterproofing sheet being wrapped around a group of electrical wires so as to conceal a portion that is to be covered by an electrical wire group support tube portion of a grommet, thus causing the waterproofing agent to move into a space between the group of electrical wires and to harden,
wherein the grommet waterproofing sheet is constituted by a shape-memory resin sheet that is moisture permeable, and has shape memory according to which micro bumps are formed on the sheet surface when heated to a glass transition temperature.

2. A wire harness comprising:
a group of electrical wires;
the grommet waterproofing sheet according to claim 1, a waterproofing agent that hardens by absorbing moisture being applied to a sheet surface of the grommet waterproofing sheet; and
a grommet that has an electrical wire group support tube portion and blocks a through-hole provided in a vehicle body panel,
wherein the grommet waterproofing sheet is wrapped around the group of electrical wires so as to conceal the group of electrical wires, adhesive tape is wrapped around two end portions of the grommet waterproofing sheet so as to fix the two end portions, the waterproofing agent is caused to move into a space between the electrical wires, the grommet waterproofing sheet restores the remembered shape due to the grommet waterproofing sheet being heated to the glass transition temperature, water molecules that have passed through the grommet waterproofing sheet having the restored shape cause the waterproofing agent to cure, and then the electrical wire group support tube portion of the grommet is placed over the waterproofing sheet.
